(19) United States
(12) Patent Application Publication
(10) Pub. No.: US 2003/0097324 A1
(43) Pub. Date: May 22, 2003

(54) Tool for analyzing investment plans

(76) Inventor: Stuart Julian Speckman, Fairfield, CT (US)

Correspondence Address: FULBRIGHT & JAWORSKI, LLP, 666 FIFTH AVE, NEW YORK, NY, 10103-3198, US

(21) Appl. No.: 10/301,033

(22) Filed: Nov. 21, 2002

Related U.S. Application Data
(60) Provisional application No. 60/332,068, filed on Nov. 21, 2001.

(51) Int. Cl. G06F 17/60

(52) U.S. Cl. 705/36

(57) ABSTRACT

A method, computer based or otherwise, for comparing a plurality of investment plans by accessing investor-specific information and investment-specific information and generating a plurality of investment plans based on said investor-specific and investment-specific information. These plans are compared, and the comparisons displayed, to determine which investment plan is best for the investor.

### PRIORITY

This application is a continuation-in-part of U.S. application Ser. No. 60/332,068 filed on Nov. 21, 2001, which is incorporated herein in its entirety.

### FIELD OF THE INVENTION

The present invention relates to investment analysis tools which permit the user to compare multiple possible investment plans, taking into account numerous variables, assumptions and options bearing on the respective investment plans. Such variables and options include but are not limited to investment account type and investment form (mutual funds, stocks, bonds, REITs, etc.); investment allocation (for instance the ratio of stocks to bonds); investment goals; present and future investment contributions; tax filing status; the effect of federal and state; the effect of long and short term capital gains taxes; the age(s) of the investor(s) and beneficiary(ies); the time horizon(s) for the liquidation of investments, and investment use upon liquidation; rates of return on investments, rates of inflation; investor's expected or potential income increases or decreases; and other variables. The investment tool further permits the user to change the variable, assumptions and options in one or more of the plans being compared to permit consideration of the performance of investment plans under different potential real world circumstances.

### BACKGROUND

Investors are often confronted with multiple paths to reach investment goals. For instance, saving for retirement can involve contributing to and managing IRAs, 401(k) plans, annuities, stock and bond portfolios, trusts, and numerous other investment “vehicles”. An investor saving for college education expenses for a child or grandchild is faced with a similar array of investment choices and options, which also include in and out of state 529 plans, and accounts established under the Uniform Gifts to Minors Act and Uniform Transfers to Minors Act (UGMA/UTMA). Certain investors also seek to reduce the size of their estate, typically for tax reasons and as a means to transfer wealth to children, grand children or others, either as outright transfers or as investments and contribution to one or more of the accounts referred to above and herein.

In these and other investment situations, there are myriad tax, investment and contribution rules to consider. Given the financial circumstances, obligations and goals of a particular investor, certain investment vehicles will be preferable to others—an annuity may provide the flexibility needed by one investor, while a 529 plan might be preferable to another investor based on tax considerations. Choosing the right investment plan from among the many possibilities is, obviously, very important, but also very difficult. For a parent saving for a child's college education, making the right decision might reduce the amount of necessary contributions by thousands of dollars, or result in greater accumulation for a given contribution amount. Making a wrong decision could result in having insufficient funds to pay for an education. In the retirement contexts, the choice of an investment plan could have a profound impact on retirement lifestyle including quality of medical care which can be afforded.

Until now, performing comparisons of different investment vehicles, in particular comparisons closely tailored to an investor's specific needs and goals, as well as his or her financial, tax and/or estate situation, was not possible. Referring once again to the example of college savings, the calculation of even a single college-funding scenario on a post-federal-tax basis is uncommon. The calculation of an investment scenario on post federal and state tax bases, tailored to the investor's specific tax, financial, and estate situations, and accounting for a number of necessary assumptions, is simply unavailable. The performance of several such concurrent scenarios is of course also not available.

Paper-based charts exist which highlight differences between types of accounts. These are common in brochures and on the internet. For example, many fund companies have static, “one size fits all” charts that state, for instance, that a generic 529 account may grow tax free if it is used for college, though an UTMA will be taxable, and a traditional IRA will grow tax deferred. There also exists very generic “taxable vs. tax-free” graphs that detail the differences in account values. Moreover, there are rudimentary “calculators” available that do hypothetical projections by projecting future values of a generic tax-free account, such as a 529 account, versus a generic taxable or tax-deferred account. (For example, many web sites permit the investor to project the value of a 529 account at any point in the future and to change assumptions about a single variable—market appreciation.) These “calculators” do not permit the consideration of the many other relevant variables such as investment account type and investment form (mutual funds, stocks, bonds, REITs, etc.); investment allocation (for instance the ratio of stocks to bonds); investment goals; present and future investment contributions; tax filing status; the effect of federal and state; the effect of long and short term capital gains taxes; the age(s) of the investor(s) and beneficiary(ies); the time horizon(s) for the liquidation of investments, and investment use upon liquidation; rates of return on investments, rates of inflation; investor's expected or potential income increases or decreases; and other variables. Even the best forecasting software employed by CPAs and tax professionals fails to address (a) the effects of sales charges (on mutual funds, for example); (b) year-by-year changes in investment growth rates; (c) tax penalties (like the 10% early withdrawal penalty); and (d) various contribution and withdrawal scenarios.

Further still, no calculator is known which permits the user to define the level of currently taxable distributions, what portion will be tax free and what portion is to be taxed at long term gains rates, nor is there a known calculator which accounts for unique taxation rules, such as the “kiddie tax”.

Finally, most if not all existing worksheets, charts, and interactive calculators suffer the additional infirmity of having to assume that a taxable account contains only interest and dividend bearing investments. They further assume and that the interest and dividends are distributed each year. These are tremendously simplistic assumptions, and deviate from real world issues in important respects. For example, an investor may have a taxable account that contains tax efficient mutual funds, and therefore receive little, if any, taxable distributions. Such an account would act as a tax-deferred account, but with one big difference: long-term gains would not treated as earned income, as they are in IRAs, 401(k)s, and annuities. No existing modeling tool permits investors to model a taxable account and distinguish between the various tax treatments of the underlying investments. Tax free municipal bonds are almost as likely to be found in a taxable account as corporate and government bonds, both of which are taxable. Taxable accounts may contain long-term gains property. To assume that the account treats this property as short-term gains property means that the investor will be taxed at a rate of 39.6% instead of 20% (under pre-2001 Tax Act rules). This is unrealistic.

### OBJECTS OF THE INVENTION

Based on the shortcomings of the prior art, outlined in-part above, it is an object of the present invention to provide an investment tool which is able to calculate and compare investment returns over time for two or more investment plans.

It is another object of the present invention to provide an investment tool which is capable of taking into account investor-specific variables and assumptions in calculating investment returns over time, the variable and assumptions including but not limited to investment account type and investment form (mutual funds, stocks, bonds, REITs, etc.); investment allocation (for instance the ratio of stocks to bonds); investment goals; present and future investment contributions; tax filing status; the effect of federal and state; the effect of long and short term capital gains taxes; the age(s) of the investor(s) and beneficiary(ies); the time horizon(s) for the liquidation of investments, and investment use upon liquidation; rates of return on investments, rates of inflation; investor's expected or potential income increases or decreases; and other variables.

It is another object of the present invention to provide a method for comparing investment plans by accessing investor-specific information, accessing investment-related information, generating a plurality of investment plans based on investor-specific and investment-specific information; and comparing each of the investment plans to determine which investment plan optimizes an investor's financial status.

It is another object of the present invention to provide a method for comparing investment plans by accessing investor-specific information on the internet, accessing investment-related information via the internet, generating investment plans based on said investor-specific and investment-specific information, comparing these investment plans to determine which investment plan optimizes an investor's financial status, and making available on the internet reports summarizing the comparisons.

It is another object of the present invention to provide a computer readable medium having code for comparing a plurality of investment plans by accessing investor-specific information, accessing investment-related information; generating investment plans based on investor-specific and investment-specific information; and comparing investment plans to determine which investment plan optimizes an investor's financial status.

It is yet another object of the present invention to provide an investment tool which is able to calculate and compare values for reductions in estate values over time for two or more estate reduction investment plans.

Various other objects of the present inventions will become readily apparent from the ensuing detailed description and drawings.

### SUMMARY OF THE INVENTION

The present invention is a computer-based analysis tool (variously described herein as “program”, “analysis program”, “analysis tool”, and “invention”) which empowers investors by allowing them to evaluate the pros and cons of various investment choices confidently and objectively.

An important aspect of the invention is its ability to compare two or more investment plans, each plan tailored to take into account the particular goals of the investor as well as certain assumptions selected by the investor. The inventive investment analysis tool helps investors evaluate the various investment and account plans as they relate to achieving a particular investment goal, for example funding an education, retiring, reducing estate size, saving for future needs, or any other goal. The investor is faced with two basic decisions: What type of account to use and what investment product to employ. The inventive investment tool helps investors make better decisions.

With better decision-making abilities, their account balances could grow faster given a predetermined investment/contribution level, or the costs involved in reaching a predetermined investment accumulation goal could be lower. Referring, for example, to investment goal of educational savings, if a college education costs $50,000 in today's dollars and is projected to cost $200,000 in fifteen years, the investment tool may help investors select an investment option whereby a contribution of “only” $40,000 is projected to cover the $200,000 college costs in fifteen tears. The investor thus saves $10,000 of today's dollars. Alternately, the investment tool could guide the investor towards an investment plan that could grow a $50,000 current investment to $250,000 in fifteen years rather than “only” $200,000. The investor has accumulated an “extra” $50,000 in fifteen years.

More specifically, the invention is an investment tool which allows investors to do investment scenario forecasting using any type of account, such as IRAs, 401(k)s, UGMA/UTMA accounts, annuities, taxable investment accounts (savings, mutual funds, individual securities such as stocks, bonds, etc.), 529 plans and any other investment vehicle. Also included are investment analyses involving estate reduction. The analysis program displays account balances at any chronological point, pre- and post-tax (the state tax codes for all states, and all apsects of the 2001 Tax Act are incorporated into the invention); generates contribution and/or withdrawal schedules and other pertinent data, taking into account the investor's particulars, such as state of residency, tax bracket, investment type (such as mutual funds or individual securities), pricing schedule, state of residency, and investor income level. It also considers certain tax benefits that are available only to in-state investors, which is common with 529 plans. For example, it distinguishes between a New York investor using New York's plan or Ohio's. Lastly, it considers the effects of any penalties, such as the 10% penalty for early withdrawals from an IRA.

After acquiring the relevant data concerning the investor, the program solves for pre-tax and post-tax account values of the various types of accounts under consideration by the investor.

After this initial analysis, it is envisioned that the investor can then further manipulate, alter and modify his or her personal and/or investment-related data (i.e., change assumptions as to rate of return, fees, timing of investment liquidation, use of liquidated funds, etc.) to view and evaluate recalculated/regenerated investment plan account value results and projections in different formats and/or under different scenarios. FIG. 13 depicts a computer screen interface by which the investor may change certain assumptions. That is, the investor may change his or her assumptions. For example, the investor may run various scenarios assuming different levels (say 3% versus 4%) of sales charges. This is completely unique feature in investment analysis tools. They also may assume that the investment return varies each year. This too is unique. (Rudimentary calculators, if permitting a change to the investment return assumption, require that the same return be used for all time periods.) The investor can also change assumptions as to income level. The invention employs a unique algorithm for approximation of taxable income and federal and state taxes. Hence, the invention permits the comparison of various options on an after tax basis, specific to their level of income (AGI) in their own state.

The investor may also access basic investment information from many of the inventive program's user interface screens, such as the interface screen depicted in FIG. 12.

Once the pre-tax and post tax values are determined for two or more investment scenarios, they are compared. A “differential” value, which represents the benefit of one scenario over another, is generated. Generation of differential values of this sort is unique where federal, or federal and state, taxes are taken into consideration, and independently, where variables such as those outlined above are considered and are variable.

After the differentials are generated and/or displayed, the user may select how to view the results. Charts and graphs display the actual values or the differential between scenarios. It is a unique feature of the invention that investor can re-run the scenarios assuming that the accounts will not be used for the originally intended purpose, or for the originally intended period of time. For example, compare FIGS. 9 and 11) If a 529 account is not used for “qualified educational expenses,” the withdrawals forfeit their tax-free status and become taxable as if the withdrawal was earned income, and a 10% penalty may apply. Moreover, withdrawals would be treated as earned income, and not capital gains property.

The inventive program will take into account the various tax treatments of taxable accounts. There are too many ways to calculate taxes in a taxable account to list here. However, the overall approach of the inventive program is to deduct taxes as the investor constructively receives taxable income, and to apply the proper tax rates for earned income and capital gains property on both the federal and state levels. For example, if the investor receives interest each year from a corporate bond, taxes due each year will be estimated and deducted from the account's value. If that same investor and account possess non-dividend paying growth stocks, no distributions are deemed to have been received until a withdrawal is made. Assuming that the withdrawal happens more than 365 days after the investment is made, long-term capital gains rates will apply, not current income tax rates. The program permits the user to define the level of currently taxable distributions, and then define what portion will be tax free and taxed at long term gains rates. Unique taxation rules, such as the “kiddie tax,” will be appropriately considered in the calculations.

The invention resides, typically, in a software application that exists on a web site, CD-ROM, hard drive or other computer-readable medium. It can be customized for any firm and can exist on a web site, laptop, or CD-ROM. Wizards and help files assist the user. The program may be written in several programming languages, which include, but are not limited to, Visual Basic, Flash, and HTML. Certain scripting languages may also be employed. The program may be modified or customized according to the needs of the investor and/or investment firm using it. Moreover, the accuracy of the inventive program has been checked by certified public accountants for accuracy.

### BRIEF DESCRIPTION OF THE DRAWINGS

The below detailed description is given by way of example and is not intended to limit the present invention solely to the embodiments described therein. The description is best be understood in conjunction with the accompanying drawings:

FIG. 1 is a depiction of a screen generated by the inventive program, wherein an investor's initial contribution is entered.

FIG. 2 is a depiction of a screen generated by the inventive program, wherein an investor's subsequent contribution information is entered.

FIG. 3 is a depiction of a screen generated by the inventive program, wherein an investor's preferred college type, and inflation assumptions, are entered.

FIG. 4 is a depiction of a screen generated by the inventive program, wherein an investor's time horizon information is entered.

FIG. 5 is a depiction of a screen generated by the inventive program, wherein an investor's residence, age and income information are entered.

FIG. 6 is a depiction of a screen generated by the inventive program, wherein an investor's stock pricing preferences are entered.

FIG. 7 is a depiction of a screen generated by the inventive program, wherein an investor selects an alternate account type for comparison to a default (here, a 529 plan) account type.

FIG. 8 is a depiction of a screen generated by the inventive program, wherein the investor is shown the amounts he or she are projected to have accumulated under a 529 plan at a future point in time, and the projected cost of college at the same point in time.

FIG. 9 is a depiction of a screen generated by the inventive program, wherein the investor is shown, in line graph form, the projected accumulation over time of a 529 account, a tax deferred annuity account, and a fully taxable UGMA account, assuming funds will be spent on qualified educational expenses.

FIG. 10 is a depiction of an screen generated by the inventive program, wherein the investor is shown, in tabular form, the projected accumulation over time of a 529 account, a tax deferred annuity account, and a fully taxable UGMA account, assuming funds will be spent on qualified educational expenses.

FIG. 11 is a depiction of a screen generated by the inventive program, wherein the investor is shown, in line graph form, the projected accumulation over time of a 529 account, a tax deferred annuity account, and a fully taxable UGMA account, assuming funds will not be spent on qualified educational expenses.

FIG. 12 is a depiction of several screens generated by the inventive program, wherein the investor is directed to additional information relating to an investment plan under consideration.

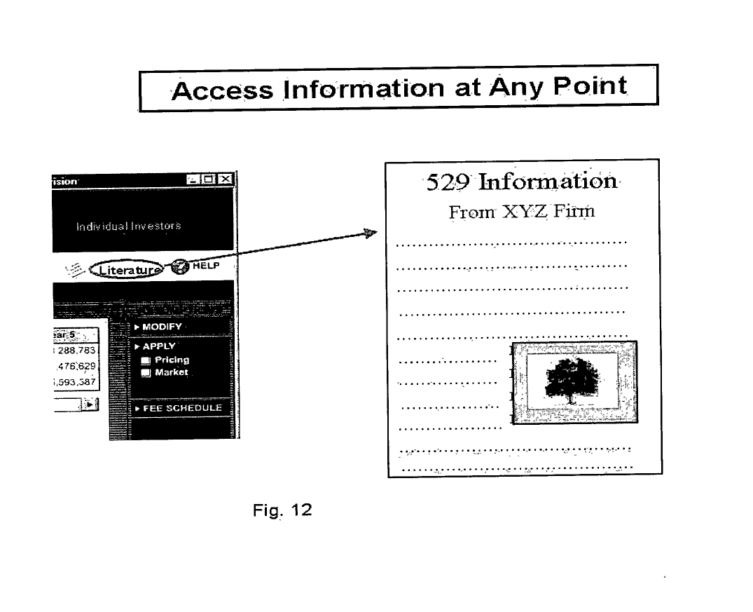

FIG. 13 is a depiction of several screens generated by the inventive program, wherein the investor is taught how to change an assumption inherent in an investment plan analysis (here, assumptions as to market rate of return).

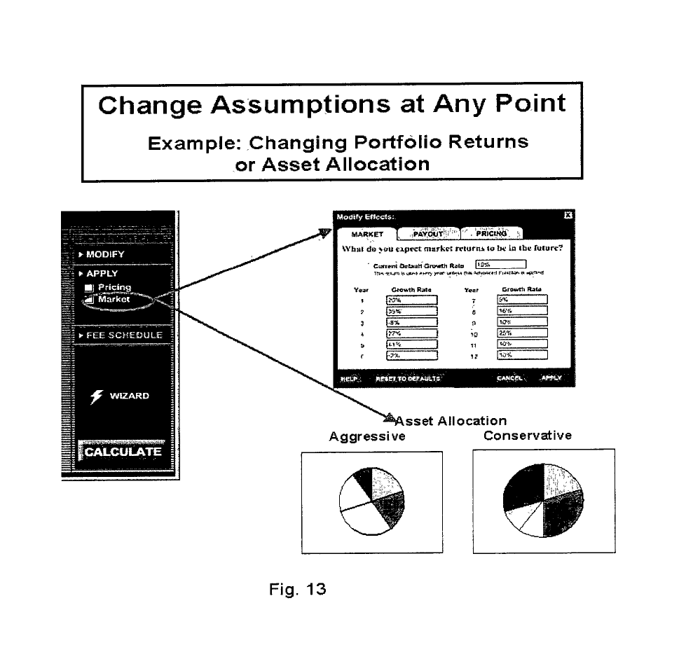

### DETAILED DESCRIPTION

The invention is best described by reference to the following examples:

### EXAMPLE 1

### Estimation of Taxable Income

To generate after tax answers the inventive analysis tool determines taxable income. Taxable income equals total income less adjustments to income, less deductions and exemptions. Assuming a gross income of $70,000, one embodiment of the inventive investment analysis tool would calculate taxable income as follows:

| | |
|---|---|
| Total Income (salaries, interest, dividends, pensions, etc.) | $70,000 |
| Less Adjustments (student loan interest, IRA deductions, etc.) | ($2,000) |
| Equals Adjusted Gross Income (AGI) | $68,000 |
| AGI | $68,000 |
| Less Standard or Itemized Deductions and Personal | ($20,400) |
| Exemptions | |
| Equals Taxable Income | $47,600 |

The ratio of AGI to total income is 97% ($68,000/$70,000). The ratio of taxable income to AGI is 70% ($47,600/$68,000). According to the IRS, these ratios are representative of all joint filers with AGI's of $20,000 to $500,000. The first ratio (97%) is often this high for most income levels. Per the second ratio (70%), the higher a taxpayer's Total Income, the higher the ratio, and vice versa. The ratio is about 75% for single filers overall.

Thus, multiplying total annual income by 70%-75% leads to a reasonable estimate of taxable income to be used with the tax tables. The actual percentage can be set depending upon the the degree of conservatism desired, and depending upon the filing status of the investor. This convention allows the inventive program to generate a good estimate of taxable income without being mired in the myriad personal deduction and exemption limits, or their phase-out provisions. In effect, the program assumes that the average taxpayer's total deductions and exemptions are about 25-30% of their AGI's.

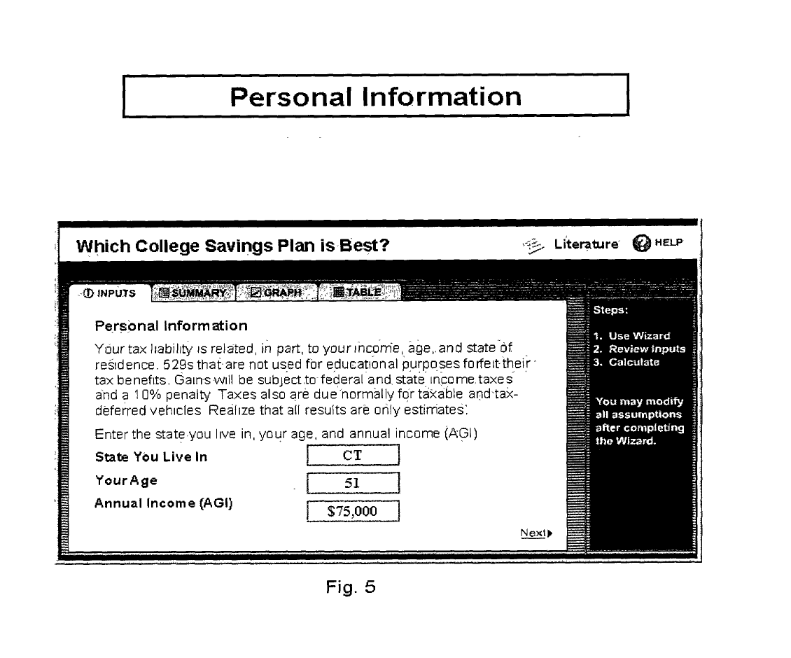

FIG. 5 is an illustration of one embodiment of the invention wherein the investor is prompted to enter information relevant to determining tax rates.

### EXAMPLE 2

### Calculation of Tax Rates, Generally

The program employs current federal and state tax tables. Using the taxable income figure derived for the user (Example 1), it determines the investor's marginal state and federal tax brackets. It then estimates taxes due under the various investment strategies. Regularly updating the program in accordance with changing federal and state tax laws, as well as the ability of the program to account for increases or decreases in income, allows for the adjustments to be made where the investor moves to higher or lower tax brackets. Upward tax bracket “creep” may result, for example, when withdrawals are included in annual income or AGI (another feature unique to the inventive analysis tool).

Federal Taxes: The analysis tool assumes that state and federal tax treatments are similar for most sources of income and types of deductions, while at the same time recognizing differences such as state taxes being deductible on federal returns but not on state returns. This assumption means that federal taxable income is a proxy for state taxable income.

State Taxes: Only a state's tax brackets and marginal rates are used. Some states use more steps and factors to determine the tax liability. Montana, for example, applies tax credits to the preliminary tax liability. The taxpayer pays less in taxes than the brackets and rates alone indicate. The program does not consider these credits, but rather errs on the side of conservatism, so the calculated state taxes due may be slightly high, in effect defining an upper limit on a tax benefit.

### EXAMPLE 3

### Analysis of Investment Plans for College Education

The inventive investment analysis tool may be used to analyze virtually all types of investment plans. A major use for this tool is in connection with analyzing college savings plans. Thus, this Example, as well as Examples 4-8, relate to the following fact pattern, which is typical investment issues facing many parents saving for college.

A four year private education is projected to cost $250,000 in future dollars (17 years from today) for a child born today. The investor is in the 30% marginal federal tax bracket and 4% marginal state tax bracket. For the sake of simplicity here, it is assumed that the investor's income and tax rates do not change in the future. Assume also that investment return averages 10% per year, and that the investor can invest a one-time sum of $50,000. The investor wishes to determine whether it is more advantageous to invest for college in a variable annuity or in a 529 plan.

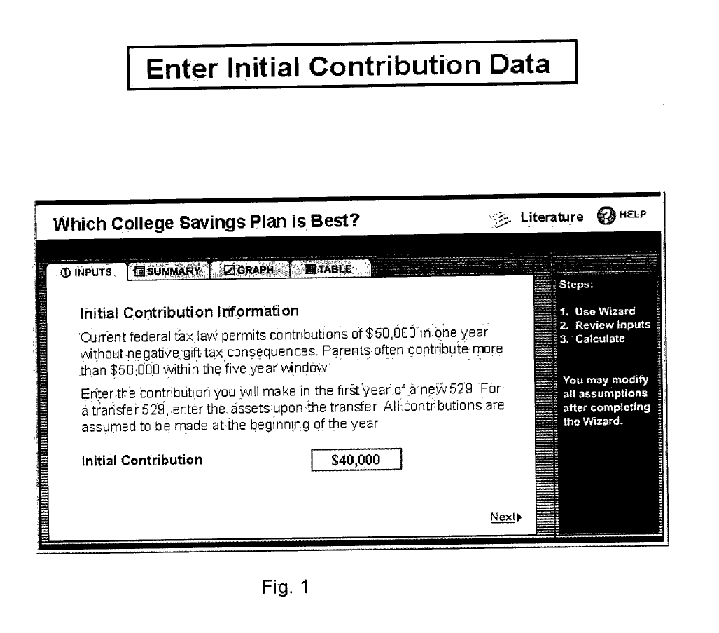

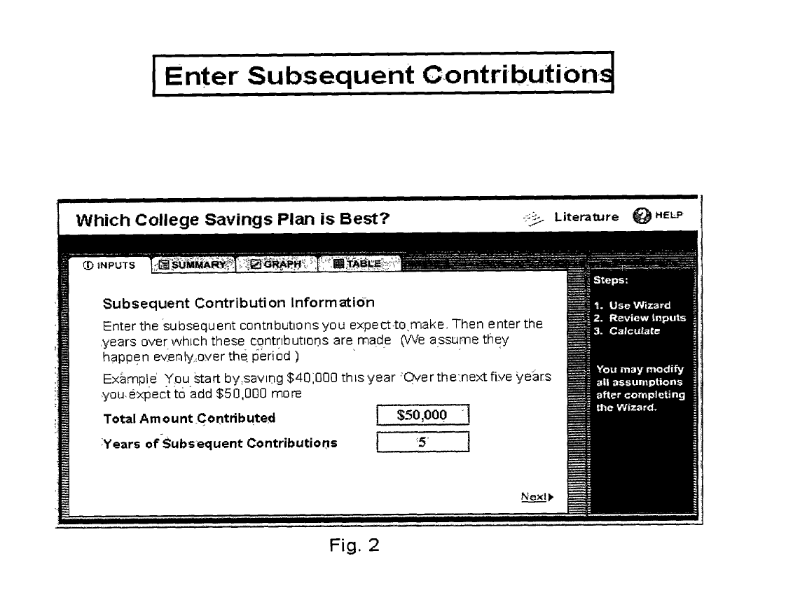

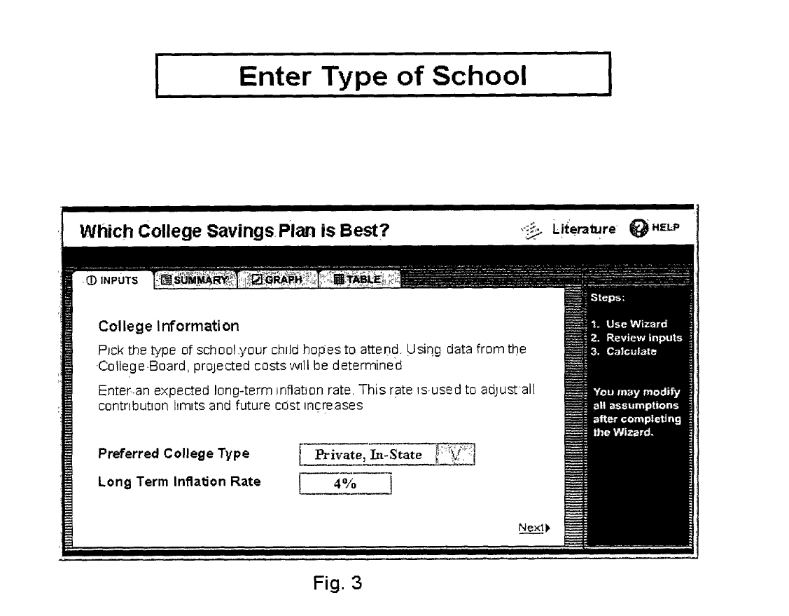

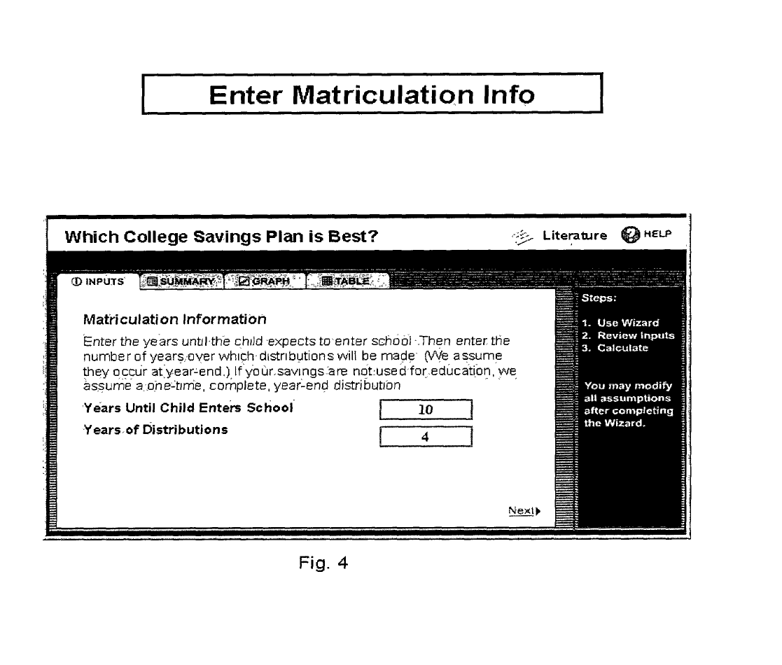

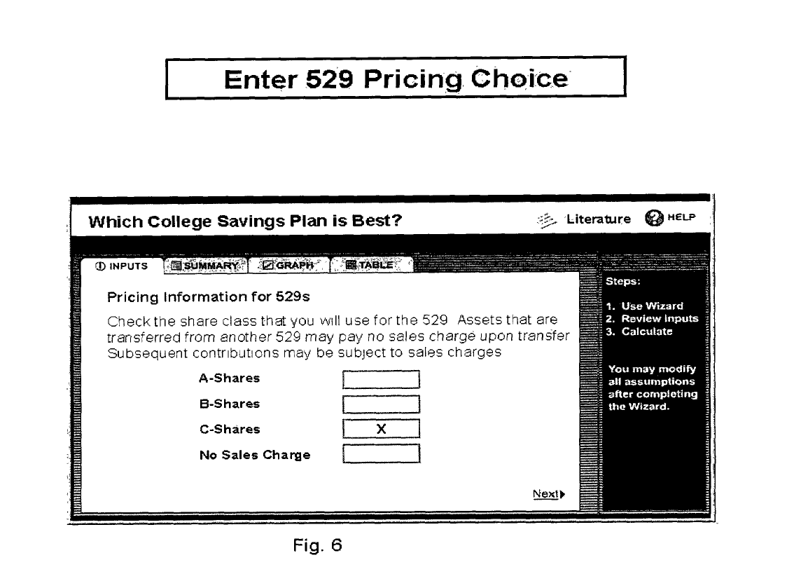

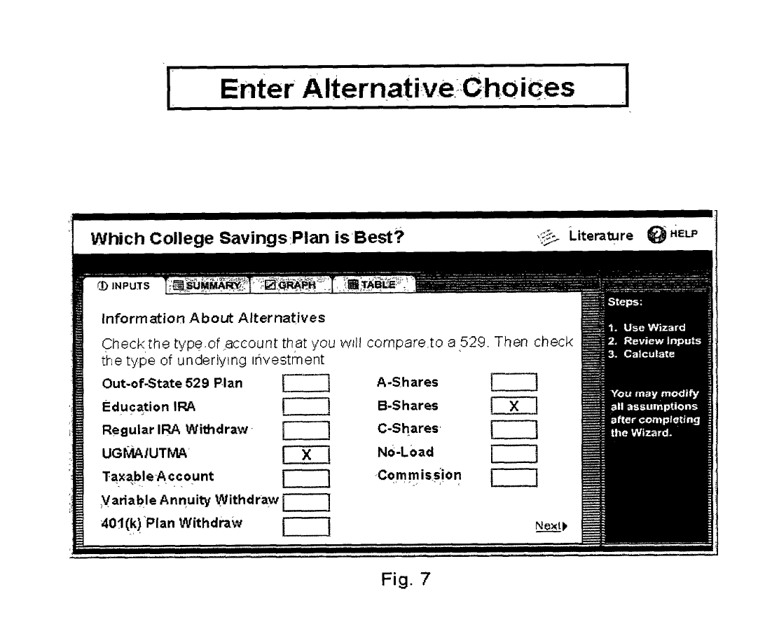

Investor-specific and investment-specific information such as that contained in the above paragraph would typically be entered into a computer running the inventive program in a series of user interface screens such as those depicted in FIGS. 1-7. Such interfaces, and the other interfaces depicted and discussed in this application may be made accessible via the internet, LANs, WANs, WLANs, wireless networks, or otherwise.

Moreover, such investor-specific and investment-specific information, or some of it, may in some instances be derived from databases. It may be desirable in certain cases to limit the information inputted or selected by the investor in favor of predetermined inputs. For instance, where the investment tool is being marketed to potential investors in 529 plans, it may be desirable that a 529 plan is always one of the investment plans analyzed and compared to other investment vehicles.

### EXAMPLE 4

### Tax Rate

Starting with the facts of Example 3, assume also that the investor itemizes his or her deductions on the federal return. Thus, state taxes are deductible on the federal return. The effective tax rate on gains is then: (1−state rate)*federal rate+state rate=(1−0.04)*0.30+0.04=32.8%. Note that it is not simply the sum of the two rates, or 34%.

### EXAMPLE 5

### Analysis of a Variable Annuity

Variable annuities are tax deferred accounts, taxes to be paid upon liquidation. The program assumes that state taxation treats all forms of earned and unearned income similarly for both taxable and tax-deferred accounts. Hence, long-term capital gains, interest income, and salary are all taxed at the same rate. Most states treat the various forms of income in this manner. On the federal level, the program distinguishes between the different types of income though it's a non-issue in a tax-deferred account.

Contributions are not tax deductible at the state or federal level. The account grows tax-deferred at the state and federal levels. The program compounds the investment return over time to arrive at a future-value-pre-tax. Withdrawals for non-qualified expenses are assessed a 10% penalty on the value of the withdrawal. If applicable, the unique contribution limits for each account type (i.e., $2,000 for IRA's) are considered. Taxes are estimated on the taxable gain portion of the account. The final, post-tax value is the future value-pre-tax minus taxes due.

Referring to the facts in Example 3, assume a complete withdrawal at the beginning of the 18^{th} year. All gains are treated as earned income. No early withdrawal penalty is assessed. The initial $50,000 investment will grow tax free for 17 years, according to the formula:

Future value=Contribution*(1+Investment Growth Rate)^{Term}

Future value=$50,000*(1+0.10)¹⁷=$252,723.

The $252,723 will then be subject to tax at the 32.8% marginal rate (Example 4) such that the account value is $186,230:

$202,723 (taxable portion of the annuity: $252,723−$50,000)*32.8%=$66,493

$252,723−$66,493=$186,230

### EXAMPLE 6

### Analysis of a 529 Plan

Contributions grow tax-free on the state and federal level. In some cases, a deduction is available to in-state residents for 529s. The calculator calculates the deduction for all time periods and nets the expected tax savings against all 529 plan contributions. The unique contribution limits for Education IRAs are considered. These IRAs are not tax deductible.

The program would, contemporaneously with the analysis in Example 5, analyze the accumulation and tax issues using a 529 plan. In the case of a 529 plan, the $50,000 would accumulate to $252,723, as described in Example 5, bot with one caveat: the net contribution amount, after taxes, would be $49,800 due to a $200 tax benefit.

Tax benefit=state marginal rate*tax ded. limit (often less than contribution)

Tax benefit=4%*$5,000=$200

Net contribution=Contribution−Tax benefit

Net contribution=$50,000−$200=$49,800

Because withdrawals from 529 plans are not taxed if used for qualifying educational purposes, the 529 plan would accumulate to $252,723 after 17 years, even “after tax”.

### EXAMPLE 7

### Comparison of Variable Annuity Versus 529 Plan

Using the inventive investment analysis tool, the investor will be able to make investment decisions resulting in his or her amassing more money for college. The invention demonstrates to the investor that while the annuity will accumulate $252,723, taxes will reduce that amount to $186,230. That amount is far below the $252,732 that a 529 plan might have grown to since, under current law, gains are tax-free on the federal and state levels.

The differential between these two figures, and thus the benefit derived by making an investment in the 529 plan and not the variable annuity, is $66,693. Thus, the investor's financial status is optimized, in this situation, by employing a 529 plan. The total of $186,230 form the annuity is also $63,770 less than the projected $250,000 that is required to fund a college education. Use of the inventive investment analysis tool makes it clear to the investor, in great detail, that the annuity investor is not the best investment from a purely monetary viewpoint. On the other hand, there may well be other reasons that the annuity is the right choice. It does permit for more investment direction and it provides insurance protection.

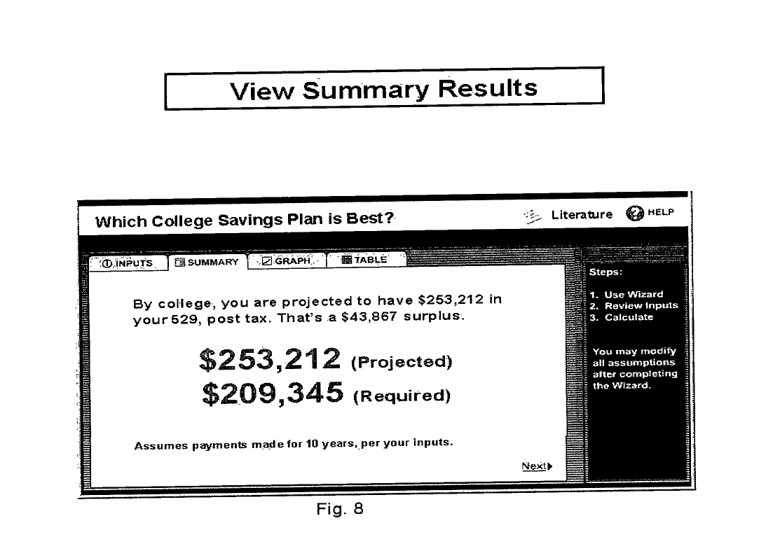

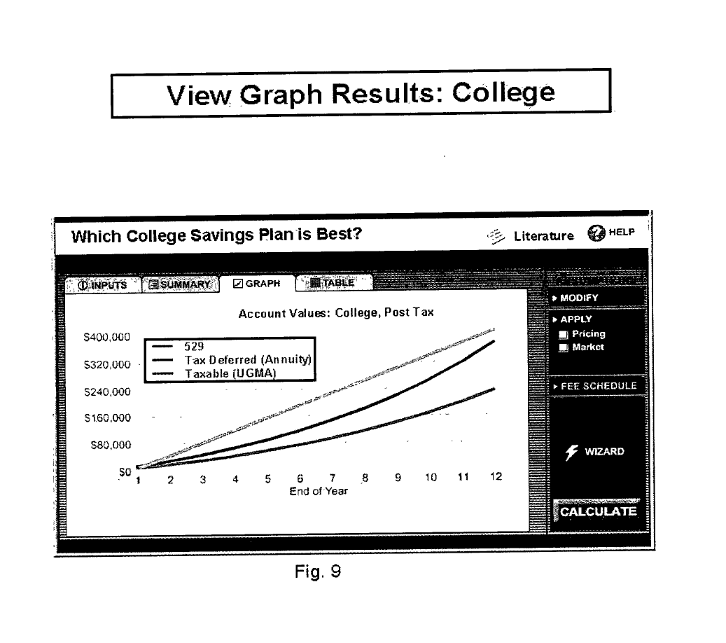

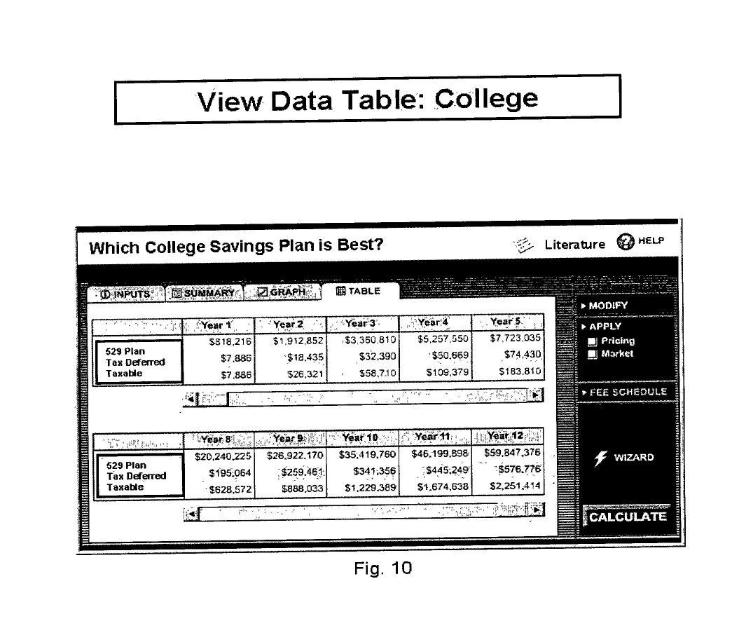

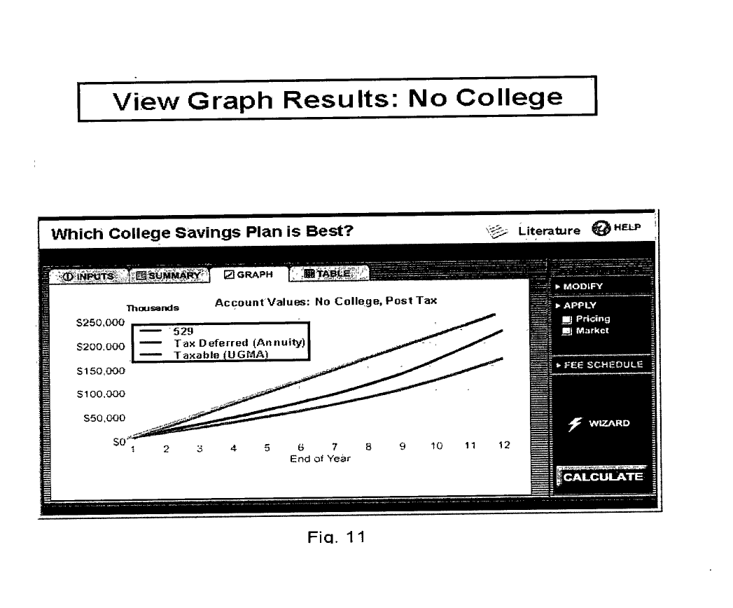

The accumulation values of the plans under consideration, and the differential(s) between these values, are visually displayed by the inventive program in screens which the investor can read and print. In a preferred embodiment of the invention, this data is displayed in several formats. FIGS. 8 through 11 show one preferred embodiment of the invention in which such data are presented in report form, line graph form and tabular form. Animation is another possible display format.

### EXAMPLE 8

### Cost Reduction

The preceding examples focused on maximizing returns on a $50,000 initial investment. The invention can also be employed to assess the amount of an initial contribution needed to reach a given accumulation goal. Equations similar to those described above are used. Referring to the facts set out in Example 3, and assuming that the plans being considered, a 529 plan and a tax-deferred account, are the same, it has been determined that $50,000 invested in the 529 plan will grow to $252,723 by the start of the 18^{th} year. The program can calculate the amount that would need to be invested initially in a tax-deferred account (variable annuity) to net the same amount, $252,723, after state and federal taxes, is $67,852, or $17,852 more than would be contributed to the 529 plan. The inventive program thus would allow the investor to determine that using the 529 rather than the annuity saves the $17,852 of today's dollars.

### OTHER ASPECTS OF THE INVENTION

The invention is able to evaluates which stock or bond to buy in which account. For example, analyze whether to buy IBM with a 2% yield in a brokerage account or Intel with a 0% yield in a Roth IRA. Thus, the invention can analyze a single trade of a single security in a specific account or a generic dollar-based strategy. For example, now you can buy Intel in an account or invest a generic $10,000/yr for 10 years.

The invention is also capable of analyzing results reflect the actual disposition of return, not just a single disposition of return. For example, distinguishing a 10% return (5% long term gains, 1% dividend yield, 2% interest, and 1% s/t gain) from a 10% return that is all long term gain. Thus, any asset allocation or security-specific trade can be evaluated on an after-tax basis properly.

While the present invention has been particularly described with respect to the illustrated embodiment, it will be appreciated that various alterations, modifications and adaptations may be made on the present disclosure, and are intended to be within the scope of the present invention. It is intended that the appended claims be interpreted as including the embodiment discussed above, those various alternatives, which have been described, and all equivalents thereto.

What is claimed:

1. A method for comparing a plurality of investment plans, comprising the steps of:
accessing investor-specific information;
accessing investment-specific information;
generating a plurality of investment plans based on said investor-specific and investment-specific information; and
comparing each of said plurality of investment plans to determine which investment plan optimizes an investor's financial status.

2. The method of claim 1, wherein the number of investment plans compared is at least two.

3. The method of claim 1, wherein the identity of at least one of said plurality of investment plans is selected, and wherein at least one of said plurality of investment plans is predetermined.

4. The method of claim 1, wherein said investment plans include two or more investment plans selected from the group consisting of in state 529 plans, out of state 529 plans, IRA's, educational IRA's, UGMA/UTMA accounts, taxable accounts, variable annuity accounts, and 401(k) plans.

5. The method of claim 1, wherein said investor-specific information comprises one or more of: investor's state of residence; investor's tax filing status; investor's current income; investor's future income; investor's age; and, beneficiary's age.

6. The method of claim 1, wherein said investment-specific information comprises one or more of: initial investment amounts; future investment contribution amounts; expected fees; expected market performance; expected inflation rates; time horizon for liquidation; expected use of liquidated investments.

7. The method of claim 1, further comprising the step of visually displaying at least two of said generated plans.

8. The method of claim 7, wherein each of said at least two plans are displayed in a report comprising one or more of graphs, tables and animations.

9. The method of claim 1, further comprising the steps of:
modifying said investor-specific information, said investment-specific information, or both; and.
regenerating said investment plans based on said modified information.

10. The method of claim 1, wherein said generated plans include projections of account values, and wherein at least one of said comparisons reveals a differential between said projected account values.

11. The method of claim 10, wherein said differential result from differing tax rules applicable to said respective plans.

12. The method of claim 10, wherein the value of said differential depends upon the length of time said plans are in effect.

13. A method for comparing a plurality of investment plans, comprising the steps of:
accessing investor-specific information via the internet;
accessing investment-specific information via the internet;
generating a plurality of investment plans based on said investor-specific and investment-specific information;
comparing each of said plurality of investment plans to determine which investment plan optimizes an investor's financial status; and
making available on the internet one or more reports summarizing said comparisons.

14. The method of claim 13, wherein access to said investor-specific information and said investment-specific information occurs through a database, through one or more internet user interfaces, or both.

15. The method of claim 13, wherein internet access occurs through one or more of: a LAN, a WAN, a WLAN and a wireless network

16. A computer readable medium comprising code for comparing a plurality of investment plans by accessing investor-specific information; accessing investment-specific information; generating a plurality of investment plans based on said investor-specific and investment-specific information; and comparing each of said plurality of investment plans to determine which investment plan optimizes an investor's financial status.

17. The method of claim 1, wherein said optimization consists of reducing estate size.
